(19) United States
(12) Patent Application Publication
(10) Pub. No.: US 2011/0150718 A1
(43) Pub. Date: Jun. 23, 2011

(54) EXHAUST-GAS TREATMENT UNIT HAVING METAL FOILS OF SMALL MATERIAL THICKNESS AND METHOD FOR PRODUCING THE SAME

(75) Inventors: LUDWIG WIERES, OVERATH (DE); JÖRG-ROMAN KONIECZNY, MUCH (DE); ROLF BRÜCK, BERGISCH GLADBACH (DE); STEFAN SEELIGER, ALTERSTEDT (DE); HUBERTUS KOTTHOFF, RUPPICHTEROTH (DE)

(73) Assignee: EMITEC GESELLSCHAFT FUR EMISSIONSTECHOLOGIE MBH, LOHMAR (DE)

(21) Appl. No.: 12/978,962

(22) Filed: Dec. 27, 2010

Related U.S. Application Data
(63) Continuation of application No. PCT/EP2009/057166, filed on Jun. 10, 2009.

(30) Foreign Application Priority Data
Jun. 27, 2008 (DE) 10 2008 030 754.8

(51) Int. Cl. B01D 53/38; B21D 33/00

(52) U.S. Cl. 422/180; 29/17.2

(57) ABSTRACT

An exhaust-gas treatment unit includes at least one housing and a honeycomb structure having channels running between end faces of the honeycomb structure and being formed by at least partially structured metal foils having a material thickness of at most 50 μm. At least part of the metal foils is constructed with a fold of a predefined width at least in the region of an end face, and the metal foil is welded to itself at a weld seam in the region of this fold. A method for producing such an exhaust-gas treatment unit using a suitable welding process is also provided.

### CROSS-REFERENCE TO RELATED APPLICATION

This is a continuation, under 35 U.S.C. §120, of copending International Application No. PCT/EP2009/057166, filed Jun. 10, 2009, which designated the United States; this application also claims the priority, under 35 U.S.C. §119, of German Patent Application DE 10 2008 030 754.8, filed Jun. 27, 2008; the prior applications are herewith incorporated by reference in their entirety.

### BACKGROUND OF THE INVENTION

### Field of the Invention

The present invention relates to an exhaust-gas treatment unit having at least one housing and a honeycomb structure having channels which run between end surfaces of the honeycomb structure and are formed by at least partially structured metal foils having a material thickness of at most 50 μm (micrometers). Such an exhaust-gas treatment unit is used, in particular, as a catalyst carrier body in exhaust systems of mobile internal combustion engines, for example in passenger motor vehicles. The invention also relates to a method for producing the exhaust-gas treatment unit.

Such exhaust-gas treatment units are often subjected to high thermal and dynamic loads in the exhaust system of a spark-ignition or diesel engine. The thermal loading arises, in particular, due to the temperature fluctuations of the exhaust gas and the catalytically induced conversion processes of the exhaust gas with the catalyst. Temperature peaks of up to 800° C., for example, are reached. Furthermore, consideration should be given to the dynamic pressure fluctuations which occur firstly due to the internal combustion processes in the engine and secondly due to vehicle vibrations. Both types of loading occur to an increased extent if the exhaust-gas treatment unit is positioned close to the internal combustion engine, in particular in contact with the internal combustion engine. In that case, even higher temperatures and more intense pressure impulses can act on the honeycomb structure.

It is precisely those ambient conditions for such an exhaust-gas treatment unit that make the use of particularly thin metal foils difficult. The loads which occur in the region of the end surface, specifically in the region of the point at which the exhaust gas enters into the honeycomb structure, can possibly lead to destruction of the metal foil. International Publication No. WO 97/15393, corresponding to U.S. Pat. No. 6,036,926, has already disclosed a honeycomb body composed of sheet-metal layers with reinforcement structures. In that case, in order to improve the durability of the honeycomb body, it is proposed that folds be formed at the face-side end regions of the sheet-metal layers. As a result of the folded regions, the thicknesses of the sheet-metal layers are doubled without the mass of the honeycomb body being significantly increased. The aim thereof is to provide stiffening of the sheet-metal layers, in such a way that the edge regions correspond in terms of their behavior to conventional, thicker sheet-metal layers.

Even though the construction of the honeycomb body with the reinforcement structure described in that document made it possible to obtain improvements even for a broad range of applications, it is nevertheless possible under particular loading for material fatigue of the metal foils to occur in the region of the end side. Furthermore, it was found that buckling of the metal foils and/or channel blockages can occur, in particular, in the case of asymmetrical or diversely curved configurations of the sheet-metal layers.

### SUMMARY OF THE INVENTION

It is accordingly an object of the invention to provide an exhaust-gas treatment unit having metal foils of small material thickness and a method for producing the same, which overcome the hereinafore-mentioned disadvantages and at least partially solve the highlighted problems of the heretofore-known devices and methods of this general type. It is sought, in particular, to specify an exhaust-gas treatment unit which has increased durability under extreme loading of the honeycomb structure. Likewise, the exhaust-gas treatment unit should be distinguished by a low weight and defined thermal behavior.

With the foregoing and other objects in view there is provided, in accordance with the invention, an exhaust-gas treatment unit, comprising at least one housing and a honeycomb structure disposed in the at least one housing and having end surfaces, at least partially structured metal foils with a material thickness of at most 50 μm and channels formed by the metal foils and extending between the end surfaces. At least a part of the metal foils is formed with a fold of a predefined width at least in vicinity of one of the end surfaces and at least one of the metal foils has a welded joint of the metal foil to itself in a region with the fold.

With regard to the honeycomb structure, it should be noted that it is preferably formed with a channel density of 100 to 800 cpsi (cells per square inch), in particular with a channel density in a range of from 100 to 400 cpsi. In this case, the channels run preferably substantially rectilinearly and parallel to one another from one end surface to the opposite end surface of the honeycomb structure, in such a way that the metal foils generate a low flow resistance. In this way, it is possible, in particular, for the pressure loss across the honeycomb structure for the exhaust gas flowing through it to be kept low, and this also results, in particular, in a reduced dynamic loading of the metal foils. It is basically possible for the honeycomb structure to be formed with at least partially smooth and partially structured metal foils, but an embodiment is preferable in which, to construct the honeycomb structure, use is made of metal foils which are either smooth or structured. A corrugation is used, in particular, as a structure. In order to realize a large surface area of the honeycomb structure in a predefined volume of the exhaust-gas treatment unit, and to ensure a low weight of the exhaust-gas treatment unit overall, it is proposed that use be made of metal foils with a material thickness of at most 50 μm. The invention is very particularly preferably used with metal foils having a material thickness of at most 30 μm or even at most 20 μm.

Folds of a predefined width are formed with the metal foils, preferably with all of the metal foils, in the region of the end surface. Folds are, in particular, partial sections of the metal foils which are bent over or folded over so as to bear against one another. Consequently, the folds are formed by the material of the metal foils themselves, and are thus formed in one piece with the metal foils. In this case, it should be noted that preferably not only smooth metal foils but rather also the structured metal foils have such folds at least close to one of the two end surfaces. It is very particularly preferable for all of the metal foils to be formed with folds at one end surface, or even at both end surfaces. A welded joint is provided in the region of the folds. Through the use of the welded joint, the folded-over or bent-over partial section of the metal foil is fixed to another section of the same metal foil. In this case, the fixing is preferably provided on a large area. In this case, the welded joint is formed in such a way that the properties of the metal foil itself are changed to the least possible extent. In this case, the welded joint is very particularly preferably produced by using an impulse welding process. This will be discussed further below in connection with an embodiment which is regarded as being particularly advantageous.

The welded joint provides the metal foil with improved and significant rigidity in the region of the end surface, which permits the use of such exhaust-gas treatment units even under extreme thermal and dynamic loading. While it has heretofore been assumed that undesired structural changes of the material and of the sheet-metal foils already occur during the brazing of such thin metal foils, it has been discovered in this case for the first time that a corresponding welded joint stabilizes the folds and therefore permits a further considerable improvement in the durability of such metal foils during use.

In accordance with another feature of the exhaust-gas treatment unit of the invention, the welded joint extends over the width of the fold and an extent of the fold along the metal foil. This means, in particular, that a welded joint is formed over the entire contact surface of the fold against the metal foil itself. It is thereby also sought, in particular, to prevent significant cavities from being formed by the fold which, in particular, hinder the contacting of adjacent metal foils and the joining connection thereof and therefore a uniform construction of the honeycomb structure. Furthermore, it can also be ensured in this way that the mechanical behavior of the metal foils is constant over the entire extent close to the end surface. With regard to “width,” it should be noted that this should be determined substantially proceeding from the end surface in the direction of the channels, or perpendicular to the end surface. The “extent” of the metal foil is determined, for example, in the plane of the end surface and substantially follows the profile of the metal foil on the end surface. It is self-evidently possible for the welded joints themselves to also have discontinuities, such as may arise, for example, during a clocked impulse welding process. The flexibility of the foil can be positively influenced in this way.

In accordance with a further feature of the invention, it is advantageous for the width of the folds to lie in a range of from 2 to 10 mm (millimeters). The width very particularly preferably lies in a range between 4 mm and 8 mm. If the width is selected to be smaller, problems can arise during the formation of the welded joint. Furthermore, it may then not be possible to ensure uniform formation of folds. If the fold is provided with a relatively large width, uniform formation of the welded joint over the entire width is difficult. Furthermore, it should be taken into consideration that the weight of the exhaust-gas treatment unit also increases with a greater width of the fold.

In accordance with an added feature of the invention, at least a part of the metal foils has holes outside the fold. The holes may, in particular, make up more than 40% or even more than 60% of the area of the metal foils between the folds or between the fold and an end surface. In this way, it is firstly possible for the weight of the exhaust-gas treatment unit to be further reduced, and secondly it can also be provided in this way that thorough mixing of the exhaust-gas flows takes place in the interior of the exhaust-gas treatment unit. As a result of the flow exchange, a particularly turbulent flow is realized in the interior of the exhaust-gas treatment unit, as a result of which, in particular, the contact of the exhaust gas with a catalyst applied to the metal foils is improved. In this case, the holes may, in particular, have a size of at least 2 mm² (square millimeters) or even at least 1 cm² (square centimeter) or even at least 3 cm².

Protruding guide surfaces may also be formed on the foils and, in particular, project in each case into a channel. The guide surfaces serve, in particular, to deflect the flow of the exhaust gas through the exhaust-gas treatment unit. The guide surfaces may adjoin holes and/or be formed opposite the holes.

In accordance with an additional feature of the invention, it is advantageous for the housing to have a multiplicity of local indentations directed toward the honeycomb structure. This means, in particular, a housing which has, for example, a cylindrical, oval or similar basic shape but which is formed with a multiplicity of local indentations which point inward. The indentations may have a round and/or polygonal base area. The local indentations have, for example, a base area of at least 2 cm² (square centimeters), if appropriate even at least 5 cm². As a result of the local indentations, the contact regions with the honeycomb structure are reduced, so that the honeycomb structure is more effectively thermally decoupled from the environment. Furthermore, such a construction of the housing results in stiffening, in such a way that in this case it is possible, in particular, to use small housing thicknesses, for example housing thicknesses of less than 1 mm (millimeter) or even less than 0.5 mm. This effect also has the result that the exhaust-gas treatment unit can be formed with an even lower weight.

It is additionally or alternatively possible for the housing to have a multi-layer construction. This means, for example, that a plurality of thin casing foils are provided (positioned concentrically with respect to one another). If appropriate, insulation may also be provided between an inner casing foil and an outer casing foil in order to prevent a dissipation of heat (by radiation) to the outside.

In accordance with yet another feature of the exhaust-gas treatment unit of the invention, structured metal foils formed adjacent a metal foil with a fold are formed with a structure height matched to the material thickness of the metal foil with a fold. This means, in particular, that the structure height of the structured metal foil compensates for the increased material thickness of the adjacent metal foil resulting from the fold, that is to say it has a correspondingly smaller or larger structure height. In other words, this means, in particular, that the structured metal foil has a varying structure height in the channel direction.

In accordance with yet a further feature of the invention, it is also advantageous for at least the metal foils to have brazed connections to one another only in the region of the folds. The brazed connections are, in particular, high-temperature brazed connections and/or vacuum brazed connections. The brazed connections are, in particular, capable of withstanding the thermal loads occurring in the exhaust system, that is to say of enduring even temperatures of 800° C. or even 1000° C. without damage. In this respect, it is proposed in this case that the brazed connections be formed only on a large area and/or locally in the region of the folds, with the fold of one of the metal foils preferably being connected to the fold of the adjacent metal foil through the use of brazed connections.

In accordance with yet an added feature of the invention, it is advantageous for at least 1% and at most 20% of inner contact points of the metal foils in the region to form a brazed connection. Due to the fact that generally structured metal foils and smooth metal foils bear against one another, a plurality of “inner contact points” (contact points between the metal foils) are formed between the metal foils, which inner contact points would basically be available for providing brazed connections. It is, however, proposed in this case that only a small proportion of the inner contact points be used for brazed connections. In other words, this also means that, for example, a multiplicity of inner contact points are formed in the direction of extent of the metal foil, but in the direction of extent, repeatedly at least five (5) inner contact points or even at least ten (10) inner contact points are not used for a brazed connection. In order to form such brazed connections, which are directed in a highly targeted manner to predetermined inner contact points, use is made, in particular, of printing processes (inkjet processes) for applying the adhesive agent and/or the brazing material.

In accordance with yet an additional feature of the invention, if such an exhaust-gas treatment unit is provided for close-coupled use in motor vehicles, it is proposed that the brazed connection be formed at a distance of 2 to 4 mm (millimeters) from the end side. The brazed connection is therefore set back slightly into the honeycomb structure. In this case, the end surface serves to provide thermal protection for the brazed connections, in such a way that even under these extreme ambient conditions, the brazed connection has a particularly durable construction.

With the objects of the invention in view, there is also provided a method for producing an exhaust-gas treatment unit having at least one housing and a honeycomb structure with end surfaces and channels extending between the end surfaces. The method comprising the following steps:

a) providing smooth and/or at least partially structured metal foils having a material thickness of at most 50 μm and an end edge;
b) forming a fold with a predefined width proceeding from the end edge of the metal foils;
c) forming a welded joint of the metal foils to themselves in vicinity of the fold;
d) configuring the metal foils to form a honeycomb structure;
e) inserting the honeycomb structure into the housing; and
f) forming brazed connections at least between the metal foils or between the metal foils and the housing.

The method proposed herein is suitable, in particular, for producing one of the above-described embodiments of the exhaust-gas treatment unit.

With regard to step b), it should be noted that the fold may be formed before and/or after the structuring of the at least partially structured metal foils. It is basically possible for the fold to be produced only at one end edge of the metal foils, but it is also possible for opposite folds to be formed at the same time and/or at different times at both end edges. In this case, the alignment of the folds may be in the same direction (that is to say, for example, both upward) or in opposite directions (one upward and one downward).

With regard to step c), it should be noted that in this case, in particular, the formation of a welded joint takes place which covers the entire width and/or the entire extent of the fold. In this case, use is made, in particular, of electric resistance welding processes (resistance pressure welding) in which the welded connection is formed over a large area due to Joule-resistance heating.

The metal foils prepared in this way can, for example, then be layered and/or stacked and then coiled and/or wound and joined to form the honeycomb structure (step d)). The honeycomb structure is then completely and/or at least partially inserted into the housing in step e). Brazing medium may be supplied to the honeycomb structure and/or the housing before and/or after step e) and, if appropriate, an adhesive agent is provided in advance at the desired locations for the subsequent brazed connections.

In step f), the honeycomb body prepared in this way is thermally treated with the brazing material, in particular inserted into a brazing furnace where the exhaust-gas treatment unit is cohesively connected through the use of the brazing material over a predefined time period and with a predefined pressure and temperature profile. The brazing process may also be carried out in a vacuum or in a protective gas atmosphere.

In accordance with another feature of the invention, in this connection, it is particularly preferable for the welded joint to be produced in step c) through the use of impulse welding. In this case, use is made, in particular, of the following process:

Name of welding process: roll seam welding
Pulse width: non-overlapping weld points
Feed rate: 0.5 to 10 meters per minute
Contact pressure of
the electrodes: 500 to 1500 Newtons per centimeter

The exhaust-gas treatment unit is used preferably as a catalyst carrier body in exhaust systems of mobile internal combustion engines such as, for example, diesel or spark-ignition engines in passenger motor vehicles. Due to the low weight and high loadability, the exhaust-gas treatment units are particularly preferable for use in sports vehicles.

Other features which are considered as characteristic for the invention are set forth in the appended claims, noting that the features specified individually in the claims may be combined with one another in any desired technologically meaningful way and form further embodiments of the invention.

Although the invention is illustrated and described herein as embodied in an exhaust-gas treatment unit having metal foils of small material thickness and a method of producing the same, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE SEVERAL VIEWS OF THE DRAWING

FIG. 1 is a diagrammatic, end-elevational view of an exhaust-gas treatment unit;

FIG. 2 is an enlarged, perspective view of a structured metal foil with folds;

FIG. 3 is a longitudinal-sectional view of an exhaust-gas treatment unit with a thin-walled housing;

FIG. 4 is a cross-sectional view of the housing of FIG. 3, which is taken along a line IV-IV in FIG. 3 in the direction of the arrows; and

FIG. 5 is a plan view of an exhaust system for a motor vehicle.

### DETAILED DESCRIPTION OF THE INVENTION

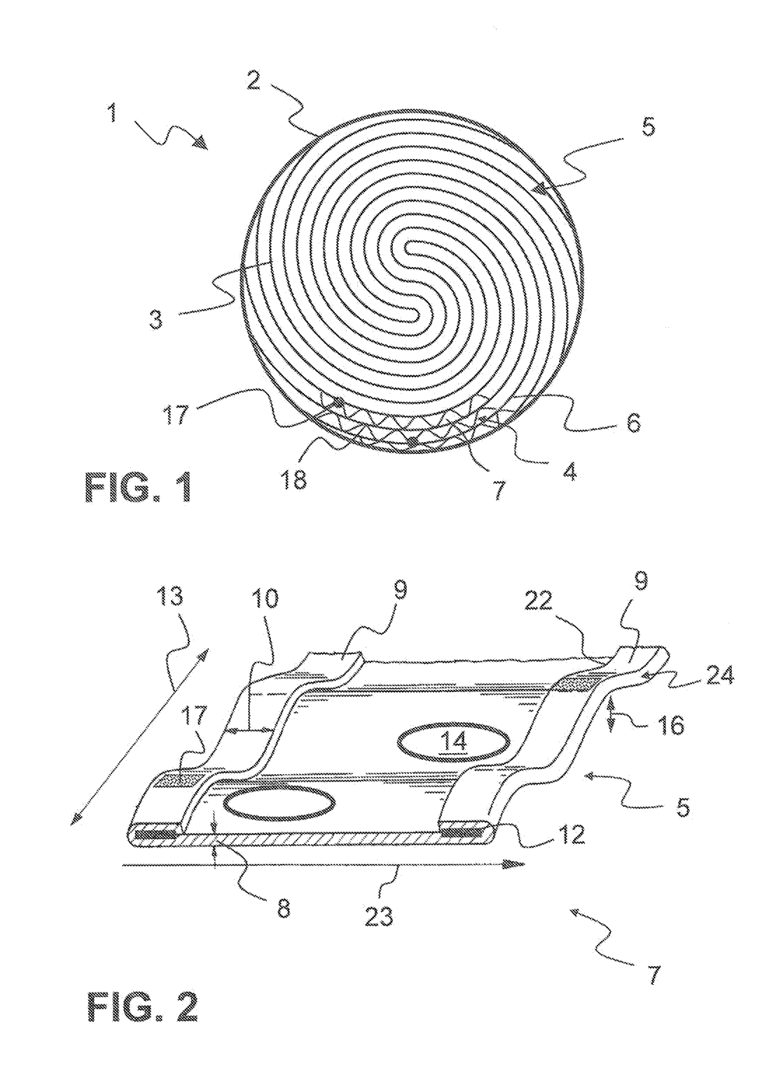

Referring now in detail to the figures of the drawing for explaining the invention and the technical field in more detail by showing particularly preferred structural variants to which the invention is not restricted, and first, particularly, to FIG. 1 thereof, there is seen a diagrammatic, end-side view of an exhaust-gas treatment unit 1 having a cylindrical housing 2 and a honeycomb structure 3 disposed therein. The honeycomb structure 3 is formed with smooth metal foils 6 and structured metal foils 7 which run in an S-shape. The metal foils 6, 7 form channels 4 which in this case run perpendicular to an end surface 5 (into the plane of the drawing). Adjacent smooth metal foils 6 and structured metal foils 7 make contact with one another repeatedly, in such a way that a multiplicity of inner contact points 18 between the metal foils is formed. Local brazed connections 17, which are also formed in this case and shown diagrammatically, are provided only at a small number of the inner contact points 18.

FIG. 2 shows a (lightly) structured metal foil 7. It should be noted that FIG. 2 is not drawn to scale. This relates, in particular, to ratios of a structure height 16 to an extent 13, a width 10 and/or a length of the metal foil in a channel direction 23. A number and size of illustrated holes 14 also need not be to scale.

At any rate, it can be seen from the structured metal foil 7 that a structure 24 is formed in a corrugated manner, wherein in this case a substantially consistent structure height 16 is formed in the direction of extent 13. This is, however, not imperatively necessary. One crimp or fold 9 with the same alignment (in this case toward the upper side only) is provided at each of the two opposite end surfaces 5. The folds 9 are formed by virtue of a partial section of the structured metal foil 7 adjacent an end edge 22 being bent over or folded over and laid against the surface of the metal foil. In this way, a fold 9 is formed, in particular, with a width of 4 to 8 mm. In order to fix the fold 9 to the structured metal foil 7, a welded joint 12 is formed on a large area in the region of the fold 9. This has the effect, in particular, that an otherwise very small material thickness 8 of, for example, at most 30 μm is reinforced in the region of the folds 9 and is furthermore stiffened by the welded joint 12.

At a later time, punctiform brazed connections 17, which are likewise indicated therein, are formed at some structure extrema, that is to say at wave peaks and wave troughs.

It is also possible for a multiplicity of (relatively large) holes 14 to be provided in the region between the folds 9. If appropriate, the holes 14 may also be larger than a structure width (that is to say they may cover at least one wave peak and/or one wave trough) in order to permit a gas exchange through the structured metal foil 7 into a plurality of adjacent channels.

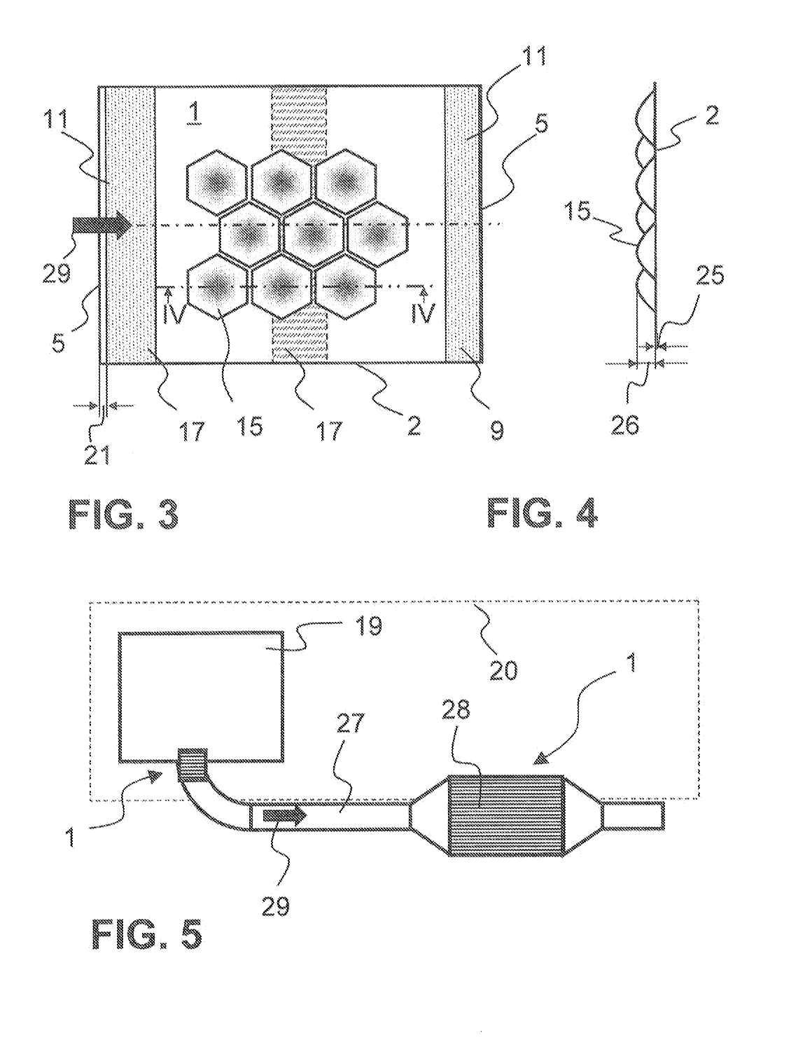

FIG. 3 shows a longitudinal section through an exhaust-gas treatment unit 1, with substantially only the housing 2 being illustrated. In particular, FIG. 3 illustrates a brazing pattern for the exhaust-gas treatment unit 1. A region 11 with the folds, upon which the exhaust gas impinges first due to a flow direction 29, is illustrated, for example, at the left in FIG. 3. The region 11, in which the brazed connections 17 of the metal foils to one another (and if appropriate also to the housing 2) are also formed, is set back from the respective end surface 5 in this case, specifically by a distance 21 of 2 to 4 mm. A region 11 with the folds 9 and the brazed connections is likewise formed at the opposite end surface 5, that is to say where the exhaust gas emerges. In this case, the region 11 is narrower and directly adjoins the end surface 5. An additional strip with a brazed connection 17 is provided approximately centrally between the two regions 11 and centrally in the housing 2. The additional strip with a brazed connection 17 may, for example, also serve to provide the only fixing of the metal foils in the housing 2. The brazing strip may also have any desired width and, for example, may even extend over the entire length of the housing 2 in the case of a close-coupled configuration of the exhaust-gas treatment unit 1.

The housing 2 is formed with a multiplicity of local indentations 15 directed toward the honeycomb structure. Although in this case only a small number of the indentations 15 are diagrammatically shown, they are provided in particular adjacent one another over the entire inner surface of the housing 2. Since the indentations are formed with the material of the housing 2 itself (by deformation of housing regions), the indentations can also be seen from the outside. In this case, the local indentations 15 have a hexagonal base area so that, for example, only the dark shaded regions in the figure form a contact surface with the honeycomb structure. A sectional view which is taken along a line IV-IV in FIG. 3 is indicated in FIG. 4 in order to diagrammatically show the shape of the local indentations 15.

Accordingly, FIG. 4 shows a section through the housing 2, wherein the housing 2 is formed with a relatively small housing thickness 25, for example in a range considerably below 1 mm. The local indentations 15 are formed into the wall of the housing 2, for example through the use of an embossing process or a similar deformation process. In this case, the indentations 15 extend over a multiple of the housing thickness 25, for example up to a depth 26 in inner regions of the housing 2 of at least 2 mm (millimeters) or even at least 5 mm or even at least 1 cm (centimeter).

FIG. 5 diagrammatically shows, by way of example and in principle, the structure of an exhaust system in a motor vehicle 20. Exhaust gas produced in an internal combustion engine 19 (for example a diesel or spark-ignition engine) is supplied through an exhaust line 27 to one or more exhaust-gas treatment units 1. In this case, the exhaust gas flows in the flow direction 29 preferably through a plurality of exhaust-gas treatment units 1. The exhaust-gas treatment units 1 may, if appropriate, be formed with different coatings 28 in order to effect different conversion and/or storage functions with regard to pollutants to be removed from the exhaust gas. FIG. 5 also diagrammatically shows that an exhaust-gas treatment unit 1 may be placed in a close-coupled position, that is to say, for example, in direct contact with the internal combustion engine 19 (or in a manifold adjoining the internal combustion engine), where particularly high thermal and dynamic loads occur. Furthermore, it is also possible for an exhaust-gas treatment unit 1 to be disposed in the underbody region of the motor vehicle 20, where the exhaust-gas treatment unit is also exposed to outside environmental conditions and usually also relatively low thermal and dynamic loads occur.

1. An exhaust-gas treatment unit, comprising:
at least one housing;
a honeycomb structure disposed in said at least one housing and having end surfaces, at least partially structured metal foils with a material thickness of at most 50 μm and channels formed by said metal foils and extending between said end surfaces;
at least a part of said metal foils being formed with a fold of a predefined width at least in vicinity of one of said end surfaces; and
at least one of said metal foils having a welded joint of said metal foil to itself in a region with said fold.

2. The exhaust-gas treatment unit according to claim 1, wherein said fold has an extent, and said welded joint extends over said width and said extent of said fold along said metal foils.

3. The exhaust-gas treatment unit according to claim 1, wherein said width of said fold is in a range of from 2 to 10 millimeters.

4. The exhaust-gas treatment unit according to claim 1, wherein at least a part of said metal foils has holes formed therein outside said fold.

5. The exhaust-gas treatment unit according to claim 1, wherein said housing has a multiplicity of local indentations directed toward said honeycomb structure.

6. The exhaust-gas treatment unit according to claim 1, which further comprises structured metal foils disposed adjacent one of said metal foils with a fold, said structured metal foils having a structure height matched to a material thickness of said one metal foil with a fold.

7. The exhaust-gas treatment unit according to claim 1, wherein at least said metal foils have brazed connections to one another only in said region with said fold.

8. The exhaust-gas treatment unit according to claim 7, wherein said metal foils have inner contact points therebetween, and at least 1% and at most 20% of said inner contact points in said region with said fold form a respective brazed connection.

9. The exhaust-gas treatment unit according to claim 7, wherein said brazed connections are disposed at a distance of 2 to 4 millimeters from one of said end surfaces, for close-coupled use in motor vehicles.

10. A method for producing an exhaust-gas treatment unit having at least one housing and a honeycomb structure with end surfaces and channels extending between the end surfaces, the method comprising the following steps:
a) providing at least one of smooth or at least partially structured metal foils having a material thickness of at most 50 μm and an end edge;
b) forming a fold with a predefined width proceeding from the end edge of the metal foils;
c) forming a welded joint of the metal foils to themselves in vicinity of the fold;
d) configuring the metal foils to form a honeycomb structure;
e) inserting the honeycomb structure into the housing; and
f) forming brazed connections at least between the metal foils or between the metal foils and the housing.

11. The method according to claim 10, which further comprises producing the welded joint in step c) by impulse welding.
